(19) United States
(12) Patent Application Publication
(10) Pub. No.: US 2012/0205504 A1
(43) Pub. Date: Aug. 16, 2012

(54) BASKET HOLDER

(75) Inventor: Joe Cute, Geneva, IL (US)

(73) Assignee: Sun Hill Industries Inc., Fairfield, CT (US)

(21) Appl. No.: 13/025,723

(22) Filed: Feb. 11, 2011

(51) Int. Cl. F16M 11/22

(52) U.S. Cl. 248/150

(57) ABSTRACT

A pot or basket holder comprising first and second frames each having top portions, wherein the top portions of the first and second frames are hingedly connected to allow the holder to be deployed in an upright position or a folded position; and a third frame hingedly connected to the first frame, wherein the third frame can be articulated between a substantially horizontal position, wherein the third frame is also removably connected to the second frame, and a stowage position wherein the third frame is disconnected from the second frame and wherein the third frame has been rotated about its hinged connection with the first frame to the stowage position. Preferably the first and second frames define the same regular shape such as a heart-shape and the third frame may be circular, square or rectangular.

### CROSS REFERENCE TO RELATED APPLICATIONS

N/A.

### TECHNICAL FIELD OF THE INVENTION

The present invention relates in general to support stands, and has more particular reference to light weight and readily portable support structures of the sort commonly provided for receiving and supporting a flower basket or vase for the attractive display of flowers, the invention pertaining more especially to display stands comprising pieces of metallic wire or bar stock of appropriate gauge secured together in a triangular prismic shape having a hinge at the apex and a hinged or removable ring to form a light weight collapsible structure of the character mentioned.

### BACKGROUND

### Field of the Disclosure

Collapsible basket stands of the sort herein are adapted to support a load, such as a flower pot or vase, above the floor or other basic use. Prior art basket stands typically involve units with shelves on which to place the baskets, units with rings or holes to support baskets, or units that support a basket at a substantial elevation.

One collapsible basket stand is described in U.S. Pat. No. 5,74,859, to Beers which discloses a rectangular stand with ledges or rests on which to place baskets. Clamps are used to secure the legs and shelves into position. Similarly, U.S. Pat. No. 494,730, also to Beers, discloses a circular stand with ledges on which to place baskets. Other shelf-like collapsible stands include U.S. Pat. No. 7,014,280, to Borgen, et al., and U.S. Pat. No. 6,854,696, to Britigan. While collapsible stands with shelves are able to display baskets, they are not adapted to that use.

Other collapsible stands are adapted to holding baskets. A typical stand of this type is described in U.S. Pat. No. 7,458,475, to Ho which discloses a modular tree-like structure for holding potted plants. Similar designs using a free standing tree-like structure can be found in U.S. Pat. No. 6,595,377 to Hetu.

Stands for holding baskets or plants using a tripod structure are described in U.S. Pat. 4,941,283, to Armstrong which discloses a tripod with a plant shelf at the apex and a rod extending downward from the apex to suspend a second plant basket between the legs of the tripod. Uphoff, in U.S. Pat. No. 2,791,391, discloses a support structure of four spaced wire elements with feet anchored to a wire loop to form a base, while the upper end of the spaced wire elements engage and support a load such as a basket.

In view of the deficiencies with the prior art basket supports/stands, it would be desirable to provide a lightweight, collapsible and portable support stand or holder for flower pots, baskets and the like.

It would also be desirable to provide a foldable or collapsible basket holder/stand in which the weight of the basket contributes to the stability of the holder/stand on which the basket is supported. It also would be desirable to have a basket holder/stand which would allow for the optional attachment of a flag or plaque above the basket. The flag or plaque can contain a greeting, such as ‘welcome,’ ‘congratulations,’ or information such as a resident's name or address. By providing a ring or other appropriate shape, a flower pot or basket can be supported, watered, and removed with minimal effort. With the ring or other shape either completely detachable or attached to the frame in a hinged or articulated manner, with an articulated joinder at the apex, the basket stand can be collapsed or folded for storage.

These and other advantages of the invention will be appreciated by reference to the detailed description of the preferred embodiment(s) that follow.

### SUMMARY OF THE INVENTION

In a first aspect, the present invention preferably comprises a pot or basket holder comprising: first and second frames each having top portions, wherein the top portions of the first and second frames are hingedly connected to allow the holder to be deployed in an upright position or a folded position; and a third frame hingedly connected to the first frame, wherein the third frame can be articulated between a substantially horizontal position, wherein the third frame is also removably connected to the second frame, and a stowage position wherein the third frame is disconnected from the second frame and wherein the third frame has been rotated about its hinged connection with the first frame to the stowage position. Preferably, the first and second frames are closed frames and have the same shape.

In another aspect of the present invention, the first and second frames are supported by legs.

In yet an additional aspect of the present invention, the third frame preferably may be a closed or open frame and preferably substantially defines a shape selected from the group consisting of a circle, square, and rectangular.

In a further additional aspect of the present invention, the first and second frames are made from a material selected from the group consisting of wood, plastic, wire, coated wire, and bar stock.

In another aspect of the present invention, the top portion of one or both of the first and second frames defines a hook on which a sign or basket may be hung when the holder is in the upright position.

In yet an additional aspect of the present invention, each of the first and second frames defines a heart shape.

In another aspect of the present invention, each of the first and second frames defines a heart shape wherein each of the top portions defines a top part of the heart shape.

In a further additional aspect of the present invention, the top part of each top portion comprises first and second curved sections meeting to form a substantially V-shaped section, the first curved portions of each of the frames are hingedly connected together and/or the second curved portions of each of the frames are hingedly connected together.

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 is a perspective view of a preferred embodiment of a basket holder of the present invention;

FIG. 2 is a front elevational view of the basket holder of FIG. 1;

FIG. 3 is a rear elevational view of the basket holder of FIG. 1;

FIG. 4 a left side elevational view of the basket holder of FIG. 1;

FIG. 5 is a right side elevational view of the basket holder of FIG. 1;

FIG. 6 is a top view of the basket holder of FIG. 1;

FIG. 7 is a bottom view of the basket holder of FIG. 1; and

FIG. 8 is a perspective view of the basket holder of FIG. 1 showing the basket holding frame disconnected from the back frame, in an articulated position so that the holder is in a position to be folded.

### DETAILED DESCRIPTION OF PREFERRED EMBODIMENT(S) OF THE INVENTION

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

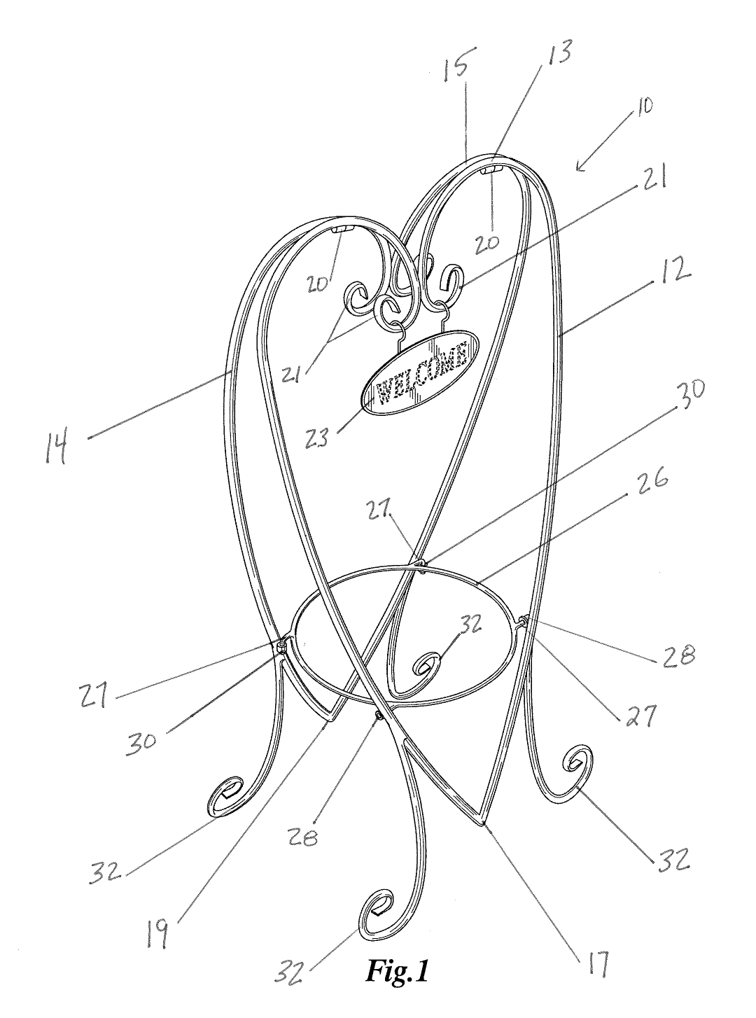

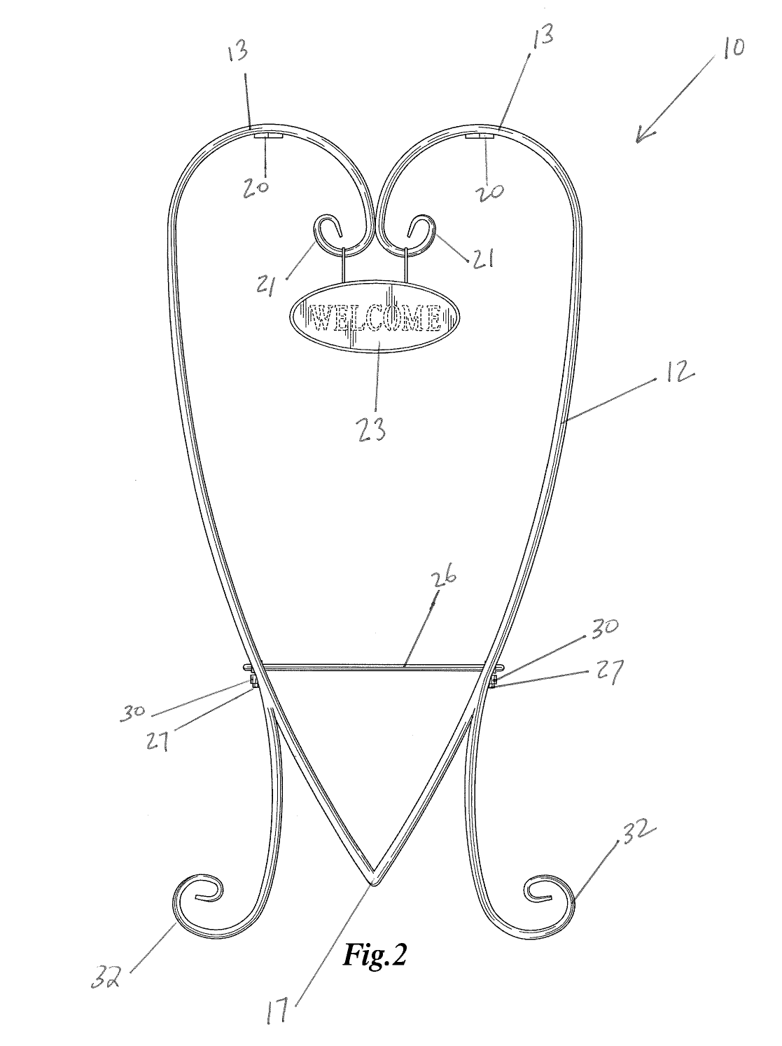

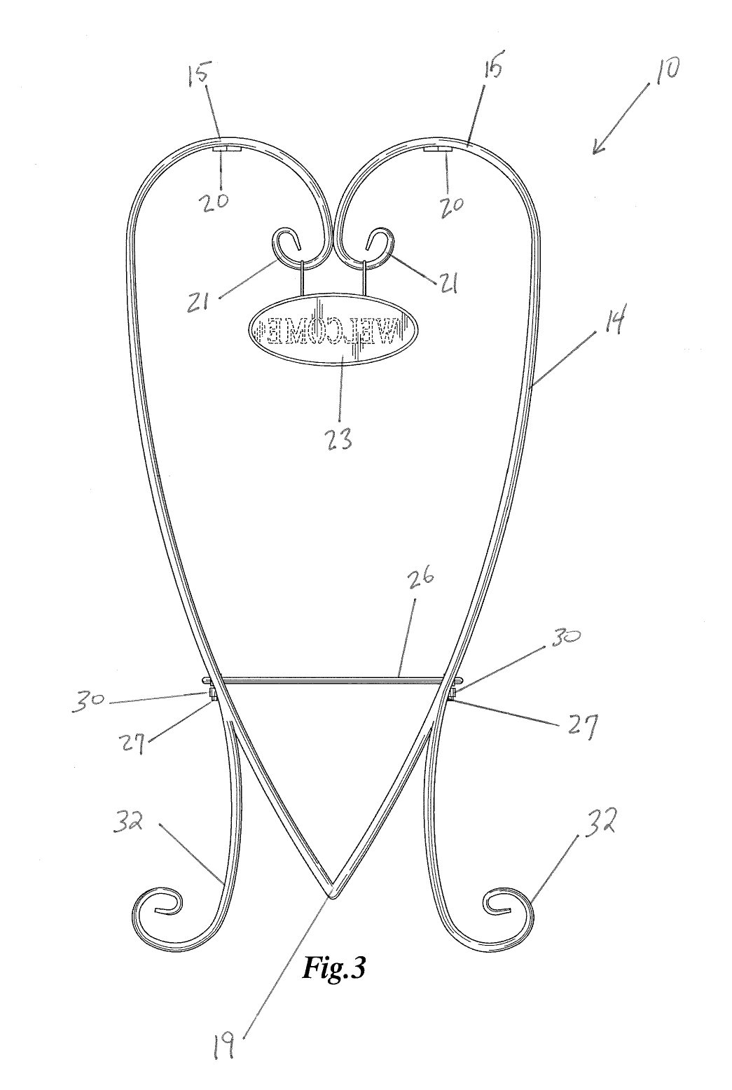

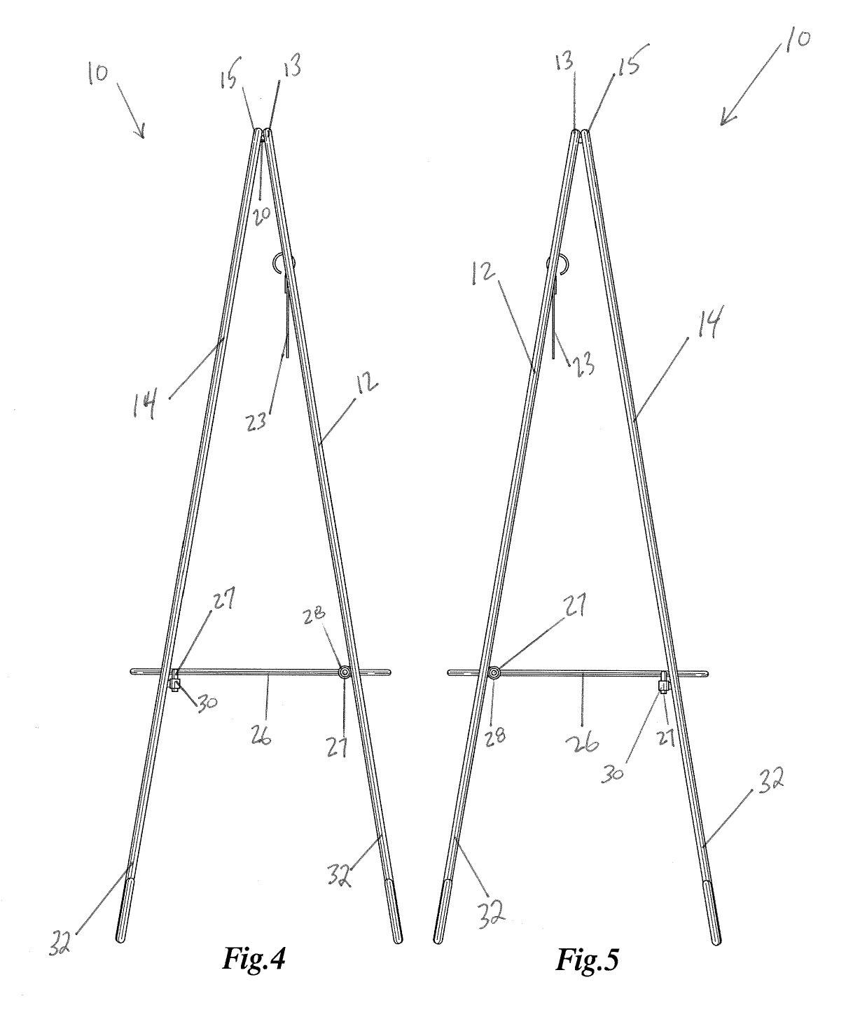

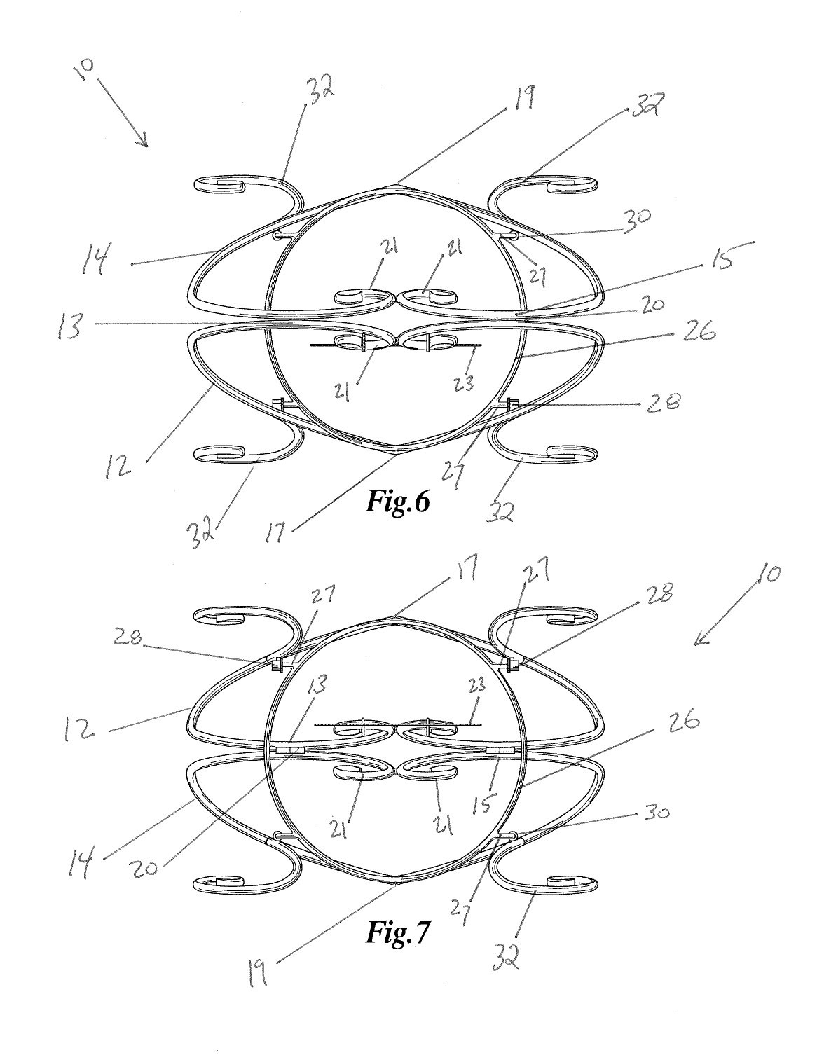

FIGS. 1-7 illustrate a preferred embodiment of a foldable basket holder 10 according to the present invention wherein the front frame 12 and the back frame 14 are preferably made from a material such as plastics in general, wood, wire, coated wire or a combination of these materials. The front frame 12 and back frame 14 may enclose an empty space. The frames 12 and 14 may be open or the frames 12 and 14 may enclose an empty space in a the shape of a circle, square, oval, rectangle, heart (cordate) or other regular or irregular shape. Preferably the front frame 12 and the back frame 14 have the same shape. Preferably, the frames 12 and 14 enclose an empty space having a heart (cordate) shape as shown in the drawings wherein the top portions 13 and 15 of the front frame 12 and back frame 14, respectively, define the top of a typical heart shape having two curved portions meeting to form a V-shape. In addition, such top portions 13 and 15 preferably may also define hooks 21 for hanging signs 23, flags, or additional flower pots or baskets and the like. Also, the bottom portions 17 and 19 of the front frame 12 and back frame 14, respectively, each preferably define the bottom V-shape of a typical heart shape.

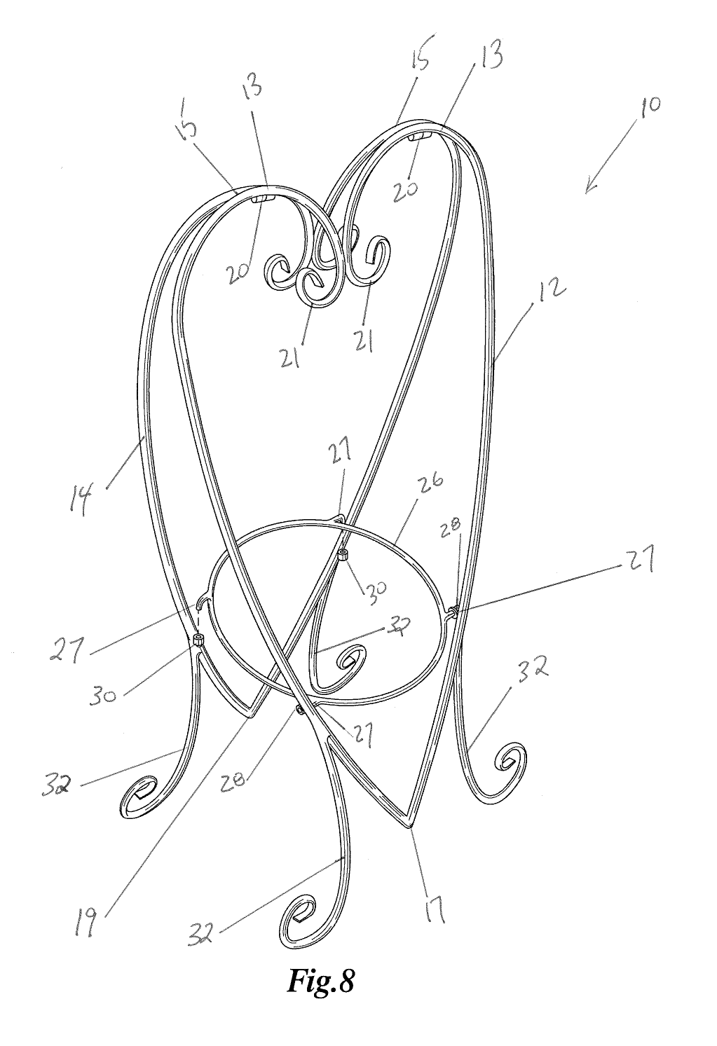

The top portions 13 and 15 of the front frame 12 and back frame 14, respectively, are preferably attached in an articulated fashion by hinges 20. The attachment of the top portions 13 and 15 may be by any suitable hinges such as a single hinge, a plurality of hinges, links, clasps, and their equivalents. The articulated attachment of the frames 12 and 14 along a common edge allows for the frames to be substantially folded together when not in use. FIG. 8 shows basket holding frame 26 (the third frame) disconnected and rotated away from the back frame 14 so that the basket holder 10 is in a position to be folded in such manner for storage.

The third, or basket holding frame 26 encloses an empty space preferably in the shape of a circle, square or rectangle or other regular shape. The third frame 26 preferably comprises fingers 27 that engage either a front hinge support 28 on front frame 12 or a back support 30 on back frame 14. As shown in FIGS. 1, 7 and 8 front hinge supports 28 receive a finger 27 that is substantially straight to hingedly connect one side of frame 26 to front frame 12. Back supports 30 receive bent fingers 27, as also shown in FIGS. 1, 7 and 8, in such a manner that the weight of a flower pot (not shown) supported in frame 26 helps to keep those fingers 27 disposed in back supports 30. As also shown in the drawings, the supports 28 and 30 are arranged such that when the third frame 26 is attached to frames 12 and 14, the third frame 26 is disposed substantially horizontally. The combination of fingers 27 and front supports 28 for attaching third frame 26 to front frame 12 preferably may also comprise hinges, links, clasps, or their equivalent, or the attachment may be detachable by detachable means such as hooks, links, clasps or their equivalents. The attachment of the third frame 26 to the back supports 30 may also preferably be made by detachable means such as hooks, links, clasps or their equivalents.

The front frame 12 and back frame 14 are preferably supported by legs 32 as shown in the drawings. Alternately, the bottom portions 17 and 19 of the front frame 12 and back frame 14, respectively, may each define a shape suitable for supporting the collapsible basket stand 10 in a upright position.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A pot or basket holder comprising:
first and second frames each having top portions, wherein the top portions of the first and second frames are hingedly connected to allow the holder to be deployed in an upright position or a folded position; and
a third frame hingedly connected to the first frame, wherein the third frame can be articulated between a substantially horizontal position, wherein the third frame is also removably connected to the second frame, and a stowage position wherein the third frame is disconnected from the second frame and wherein the third frame has been rotated about its hinged connection with the first frame to the stowage position.

2. The holder of claim 1 wherein the first and second frames are closed frames.

3. The holder of claim 1 wherein the first and second frames have the same shape.

4. The holder of claim 1 wherein the first and second frames are supported by legs.

5. The holder of claim 1 wherein the third frame substantially defines a shape selected from the group consisting of a circle, square, and rectangular.

6. The holder of claim 1 wherein the third frame substantially defines a circle.

7. The holder of claim 1 wherein the first and second frames are made from a material selected from the group consisting of wood, plastic, wire, coated wire, and bar stock.

8. The holder of claim 1 wherein the top portion of one or both of the first and second frames defines a hook.

9. The holder of claim 1 wherein each of the first and second frames defines a heart shape.

10. The holder of claim 1 wherein each of the first and second frames defines a heart shape wherein each of the top portions defines a top part of the heart shape.

11. The holder of claim 10 wherein the top part of each top portion comprises first and second curved sections meeting to form a substantially V-shaped section.

12. The holder of claim 11 wherein the first curved portions of each of the frames are hingedly connected together.

13. The holder of claim 12 wherein the second curved portions of each of the frames are hingedly connected together.

14. The holder of claim 13 wherein third frame substantially defines a circle.

15. The holder of claim 1 wherein the third frame is a closed or open frame.
